(19) United States
(12) Patent Application Publication
(10) Pub. No.: US 2024/0333657 A1
(43) Pub. Date: Oct. 3, 2024

(54) NETWORK RESOURCE CLUSTERING

(71) Applicant: SOLUTIONS HUMANITAS INC., Montreal (CA)

(72) Inventors: Abdo SHABAH, Montreal (CA); Maroua BEN ATTIA, Montreal (CA); Chuan PHAM, Montreal (CA)

(21) Appl. No.: 18/398,550

(22) Filed: Dec. 28, 2023

Related U.S. Application Data
(60) Provisional application No. 63/436,481, filed on Dec. 30, 2022.

(51) Int. Cl. H04L 47/76; H04L 47/83

(52) U.S. Cl. CPC H04L 47/76; H04L 47/83

(57) ABSTRACT

A method and a network node for handling a computation request from a requesting party. Resources messages are periodically exchanged with neighboring network nodes indicating resources usage. A computation request is received from a requesting entity via a network interface; coordination takes place with the neighboring network nodes; one or more processor unit (PU) clusters are formed using resource usage data from the resource messages; and, taking into account the computation request; resources from the one or more PU clusters are allocated to the computation request before returning the result of the computation request to the requesting entity via the network interface.

### PRIORITY STATEMENT UNDER 35 U.S.C § 0.119 (E) & 37 C.F.R. § 0.1.78

This non-provisional patent application claims priority based upon the prior U.S provisional patent application entitled “NETWORK RESOURCE CLUSTERING”, application No. 63/436,481, filed 2022 Dec. 30, in the name of Solutions Humanitas Inc., which is hereby incorporated by reference in its entirety.

### TECHNICAL FIELD

The present invention relates to a resource clustering and, more particularly, to ad hoc computing resource clustering.

### BACKGROUND

Internet-of-things (IoT) provides a multitude of connected objects with varying computing capabilities. Most of the time, the capabilities of the IoT devices are interesting for more than their primary function. The present invention explores the possibility of using these capabilities.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method performed at a network node for handling a computation request from a requesting party. The method comprises periodically exchanging resource messages with neighboring network nodes (e.g., using a broker coordinator protocol) indicating resources usage. The method also comprises receiving a computation request from a requesting entity via a network interface; coordinating, with the neighboring network nodes (e.g., using a broker coordinator protocol), creation of one or more processor unit (PU) clusters using resource usage data from the resource messages and taking into account the computation request; allocating resources from the one or more PU clusters to the computation request; and returning the result of the computation request to the requesting entity via the network interface.

Coordinating the creation of the one or more PU clusters with the neighboring nodes may optionally comprise computing at least one energy-configuration compatible with the computation request and the resource usage data; taking into account the at least one energy-configuration, computing at least one mobility-configuration compatible with the computation request and the resource usage data; and taking into account the at least one energy-configuration and the at least one mobility-configuration, computing a processing-configuration compatible with the computation request and the resource usage data.

Computing the energy-configuration may optionally comprise requesting energy-assignment of resources to a multi-agent function for the computation request, the multi-agent function having access to the computation request and the resource usage data; and receiving the at least one energy-configuration from the multi-agent function.

Computing the mobility-configuration may optionally comprise requesting mobility-assignment of resources to a multi-agent function for the computation request, the multi-agent function having access to the computation request and the resource usage data; and receiving the at least one mobility-configuration from the multi-agent function.

Computing the processing-configuration compatible with the computation request may be performed upon receipt of the at least one energy-configuration and the at least one mobility-configuration and may optionally comprise requesting assignment of the resources from the processing-configuration, one of the at least one energy-configuration and one of the at least one mobility-configuration to a multi-agent function. Allocating the resources may be performed in accordance with the assignment request upon receipt of a configuration validity confirmation from the multi-agent function.

Allocating the resources may optionally comprise providing an energy-configuration-selection message to an energy-allocation function confirming selection of the one energy-configuration; providing a mobility-configuration-selection message to a mobility-allocation function confirming selection of the one mobility-configuration; and providing a processing-configuration-selection message to a processing-allocation function confirming selection of the one processing-configuration, thereby creating the one or more PU clusters.

The multi-agent function and the one or more PU clusters may be distributed among the neighboring nodes.

Other embodiments of this aspect include corresponding computer systems, apparatus, and computer programs recorded on one or more computer storage devices, each configured to perform the actions of the methods.

One general aspect includes a network node. The network node comprises one or more processing unit (PU) processor cores; a network interface and a distributed choreographer module. The distributed choreographer module periodically exchanges resource messages with neighboring network nodes (e.g., using a broker coordinator protocol) indicating resources usage; and receives a computation request from a requesting entity via the network interface; coordinates, with the neighboring network nodes (e.g., using the broker coordinator protocol), creation of one or more PU clusters using resource usage data from the resource messages and taking into account the computation request; allocates resources from the one or more PU clusters to the computation request; and returns the result of the computation request to the requesting entity via the network interface. Other embodiments of this aspect include corresponding computer systems, apparatus, and computer programs recorded on one or more computer storage devices, each configured to perform the actions of the methods.

### BRIEF DESCRIPTION OF THE DRAWINGS

Further features and exemplary advantages of the present invention will become apparent from the following detailed description, taken in conjunction with the appended drawings, in which:

FIGS. 1A, 1B, 1C, 1D, 1E, 1F and 1G, hereinafter referred to as FIG. 1, are flow charts of exemplary methods in accordance with the teachings of the present invention;

FIG. 2 is a modular representation of an exemplary network node in accordance with the teachings of the present invention;

FIG. 3 is a flow chart of an exemplary method in accordance with the teachings of the present invention;

FIG. 4 is a nodal operation and information exchange chart in accordance with the teachings of the present invention;

FIGS. 5A, 5B, 5C and 5D, hereinafter referred to as FIG. 5, are nodal operation and information exchange charts in accordance with the teachings of the present invention.

### DETAILED DESCRIPTION

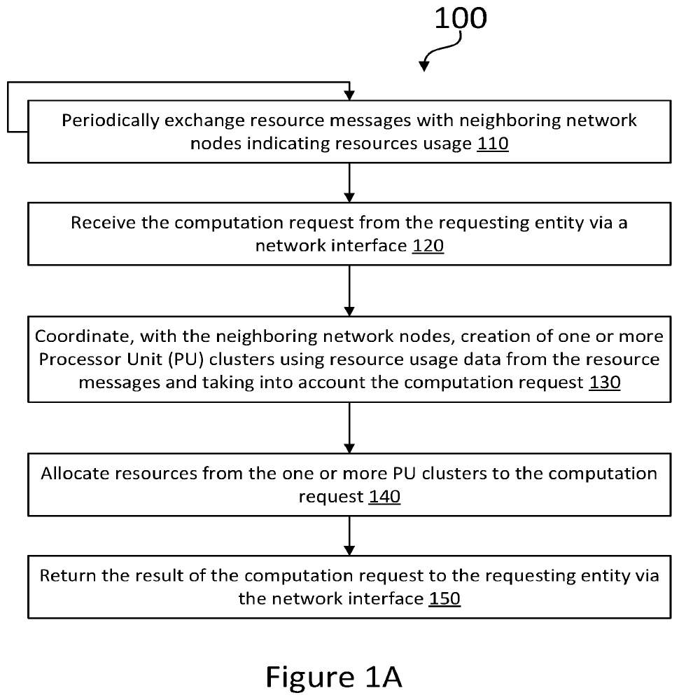

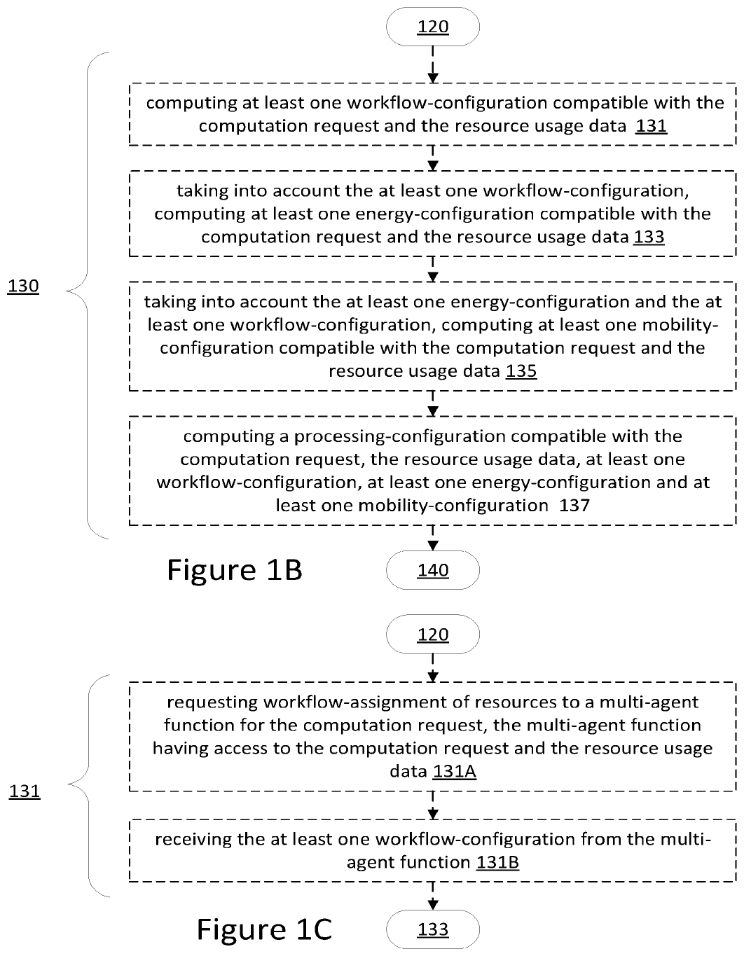

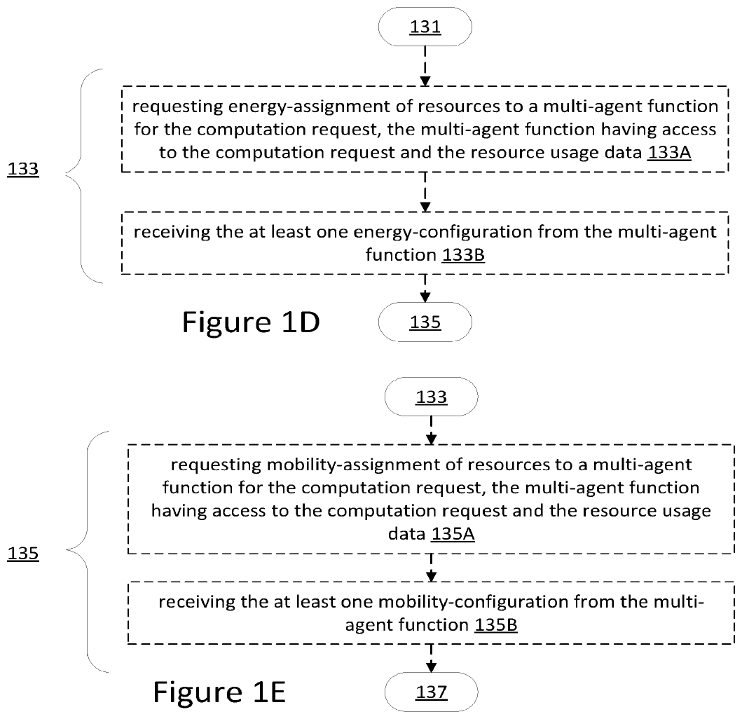

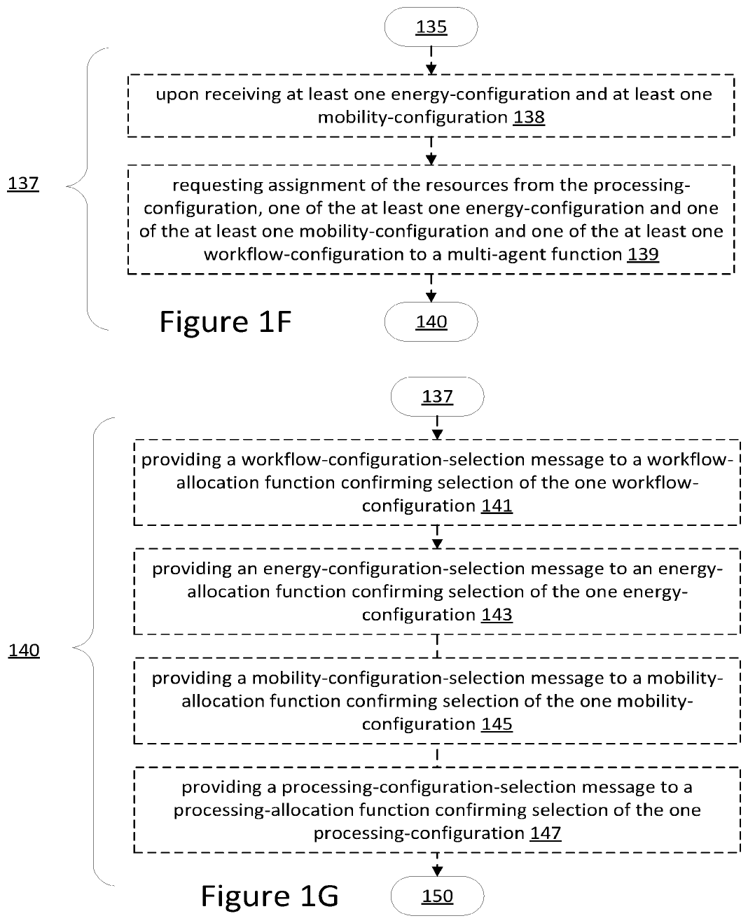

Reference is now made to the drawings in which FIG. 1, which comprises FIGS. 1A, 1B, 1C, 1D, 1E, 1F and 1G, shows a flow chart of an exemplary method 100. Although FIG. 1 shows example blocks of the method 100, in some implementations, the method 100 may include additional blocks, fewer blocks, different blocks, or differently arranged blocks than those depicted in FIG. 1. Additionally, or alternatively, two or more of the blocks of the method 100 may be performed in parallel.

As shown in FIG. 1, the method 100 may include periodically exchanging 110 resource messages with neighboring network nodes indicating resources usage. For example, the network node may periodically exchange resource messages with neighboring network nodes (e.g., using a broker coordinator protocol) indicating resources usage. As also shown in FIG. 1, the method 100 includes receiving 120 the computation request from the requesting entity via a network interface. The method 100 also include coordinating 130, with the neighboring network nodes (e.g., using a broker coordinator protocol), creation of one or more Processor Unit (PU) clusters using resource usage data from the resource messages and taking into account the computation request. The method 100 includes allocating 140 resources from the one or more PU clusters to the computation request before returning 150 the result of the computation request to the requesting entity via the network interface.

The method 100 may include additional implementations, such as any single implementation or any combination of implementations described below and/or in connection with one or more other processes described elsewhere herein. For instance, in some implementations, coordinating 130 the creation of the one or more PU clusters with the neighboring nodes may include computing 131 at least one workflow-configuration compatible with the computation request and the resource usage data and, taking into account the at least one workflow-configuration, computing 137 a processing-configuration compatible with the computation request and the resource usage data. Additionally, in selected implementations, coordinating 130 the creation of the one or more PU clusters with the neighboring nodes may include: taking into account the at least one workflow-configuration, computing 133 at least one energy-configuration compatible with the computation request and the resource usage data. computing 137 the processing-configuration compatible with the computation request and the resource usage data may therefore further take into account the at least one energy-configuration. In some implementations, coordinating 130 the creation of the one or more PU clusters with the neighboring nodes may include, taking into account the at least one energy-configuration and the at least one workflow-configuration, computing 135 at least one mobility-configuration compatible with the computation request and the resource usage data. Computing 137 the processing-configuration compatible with the computation request and the resource usage data would therefore further take into account the at least one mobility-configuration.

In some instances, alone or in combination with one or more of the other examples, computing 131 the workflow-configuration may include requesting 131A workflow-assignment of resources to a multi-agent function for the computation request and receiving 131B the at least one workflow-configuration from the multi-agent function. In this example, the multi-agent function has access to the computation request and the resource usage data.

In some instances, alone or in combination with one or more of the other examples, computing 133 the energy-configuration may include requesting 133A energy-assignment of resources to the multi-agent function for the computation request and receiving 133B the at least one energy-configuration from the multi-agent function. In this example as well, the multi-agent function has access to the computation request and the resource usage data.

In some instances, alone or in combination with one or more of the other examples, computing 135 the mobility-configuration may include requesting 135A mobility-assignment of resources to a multi-agent function for the computation request and receiving 135B the at least one mobility-configuration from the multi-agent function. In this additional example, the multi-agent function also has access to the computation request and the resource usage data.

The multi-agent function may be distributed among the neighboring nodes.

In some implementations, alone or in combination with one or more of the other examples, computing 137 the processing-configuration compatible with the computation request is performed upon receiving 138 at least one energy-configuration and at least one mobility-configuration and may include requesting 139 assignment of the resources from the processing-configuration, one of the at least one energy-configuration and one of the at least one mobility-configuration and one of the at least one workflow-configuration to a multi-agent function. Allocating 140 the resources may therefore be performed in accordance with the assignment request upon receipt of a configuration validity confirmation from the multi-agent function.

In an additional example, alone or in combination with one or more of the other examples, allocating 140 the resources may include: providing 141 a workflow-configuration-selection message to a workflow-allocation function confirming selection of the one workflow-configuration; providing 143 an energy-configuration-selection message to an energy-allocation function confirming selection of the one energy-configuration; providing 145 a mobility-configuration-selection message to a mobility-allocation function confirming selection of the one mobility-configuration and providing 147 a processing-configuration-selection message to a processing-allocation function confirming selection of the one processing-configuration; thereby creating the one or more PU clusters.

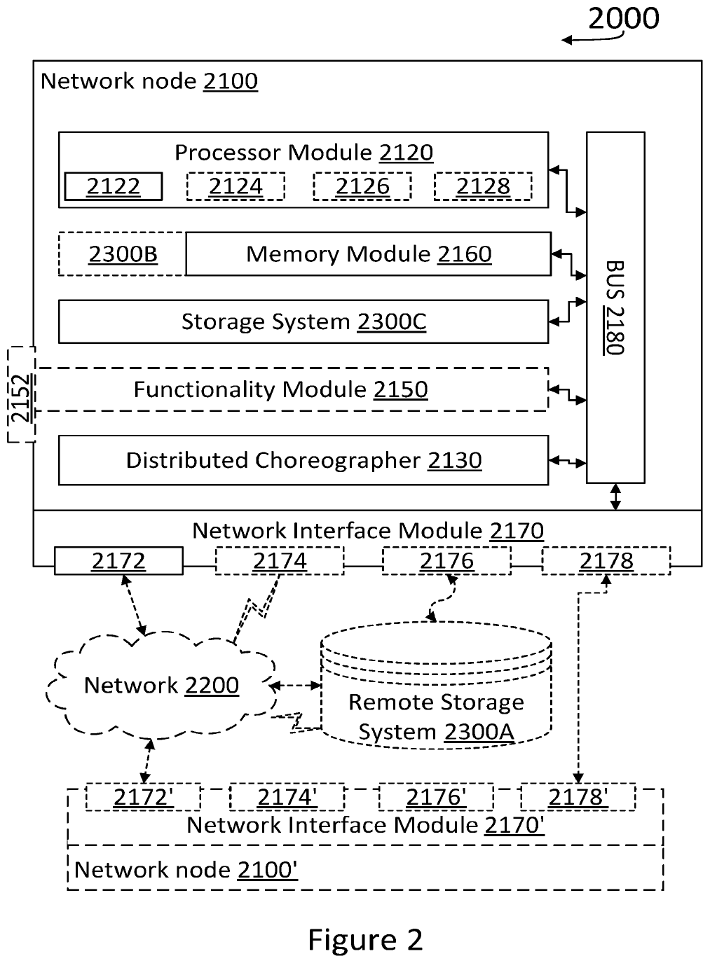

FIG. 2 shows a logical modular representation of an exemplary system 2000 comprising a network node 2100. The network node 2100 comprises a memory module 2160 and a processor module 2120. Optionally, a user interface module (not shown) may be provide as well as a functionality module. The network node comprises a network interface module 2170. The system 2000 may also include a storage system 2300. The system 2000 includes a network 2200 that may be used for accessing storage system 2300 or other nodes (e.g., 2100′).

The network node 2100 may comprise a storage system 2300 for storing and accessing long-term (i.e., non-transitory) data and may further log data while the innovation accelerator system is being used. FIG. 2 shows examples of the storage system 2300 as a distinct database system 2300A, a distinct module 2300C of the network node 2100 or a sub-module 2300B of the memory module 2160 of the network node 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the network node 2100 by a standardized or proprietary interface or via the network interface module 2170. The variants of storage system 2300 usable in the context of the present invention will be readily apparent to persons skilled in the art.

In the depicted example of FIG. 2, the network node 2100 shows an optional remote storage system 2300A which may communicate through the network 2200 with the network node 2100. The storage module 2300, (e.g., a networked data storage system) accessible to all modules of the network node 2100 via the network interface module 2170 through a network 2200, may be used to store data. The storage system 2300 may represent one or more logical or physical as well as local or remote hard disk drive (HDD) (or an array thereof). The storage system 2300 may further represent a local 2300B, 2300C or remote database 2300A made accessible to the network node 2100 by a standardized or proprietary interface. The network interface module 2170 represents at least one physical interface that can be used to communicate with other network nodes. The network interface module 2170 may be made visible to the other modules of the network node 2100 through one or more logical interfaces. The actual stacks of protocols used by the physical network interface(s) and/or logical network interface(s) of the network interface module 2170 do not affect the teachings of the present invention. The variants of processor module 2120, memory module 2160, network interface module 2170 and storage system 2300 usable in the context of the present invention will be readily apparent to persons skilled in the art.

Likewise, even though explicit mentions of the memory module 2160 and/or the processor module 2120 are not made throughout the description of the present examples, persons skilled in the art will readily recognize that such modules are used in conjunction with other modules of the network node 2170 to perform routine as well as innovative steps related to the present invention.

The processor module 2120 may represent a single processor with one or more processor cores 2122 or an array of processors, each comprising one or more processor cores 2122. Three optional processors cores 2124-2126-2128 are shown to illustrate that the actual number of processor cores is not relevant to the teachings hereof. The memory module 2160 may comprise various types of memory (different standardized or kinds of Random Access Memory (RAM) modules, memory cards, Read-Only Memory (ROM) modules, programmable ROM, etc.). The network interface module 2170 represents at least one physical interface that can be used to communicate with other network nodes. The network interface module 2170 may be made visible to the other modules of the network node 2100 through one or more logical interfaces. The actual stacks of protocols used by the physical network interface(s) and/or logical network interface(s) 2172-2178 of the network interface module 2170 do not affect the teachings of the present invention. The variants of processor module 2120, memory module 2160 and network interface module 2170 usable in the context of the present invention will be readily apparent to persons skilled in the art.

A bus 2180 is depicted as an example of means for exchanging data between the different modules of the network node 2100. The present invention is not affected by the way the different modules exchange information. For instance, the memory module 2160 and the processor module 2120 could be connected by a parallel bus, but could also be connected by a serial connection or involve an intermediate module (not shown) without affecting the teachings of the present invention.

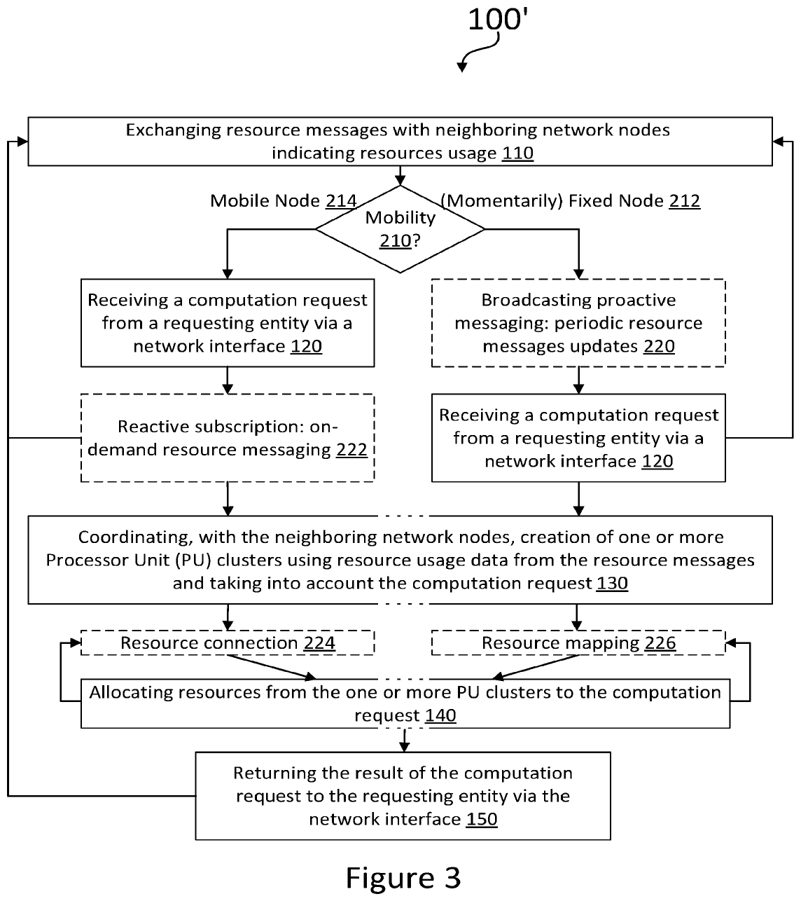

FIG. 3 shows a flow chart of an expanded method 100′ from the method 100 of FIG. 1 performed in the context of the example of FIG. 2. Although FIG. 3 shows example blocks of the method 100′, in some implementations, the method 100′ may include additional blocks, fewer blocks, different blocks, or differently arranged blocks than those depicted in FIG. 3. Additionally, or alternatively, two or more of the blocks of the method 100′ may be performed in parallel.

In the example of FIG. 3, resources messages are exchanged 110 by the network node 2100 with neighboring nodes (e.g., 2100′), for instance, using the network interface module 2170 (e.g., interface 2178 to interface 2178′ and/or interface 2172 through the network 2200 and interface 2172′). The resources messages indicate resource usage from the network node 2100. The resource messages comprise data concerning load and/or remaining capacity for the processor module 2120 and, in some instances, of the one or more processor cores 2122, 2124, 2126, 2128 of the processor module 2120. The resource messages may comprise data concerning load and/or remaining capacity for one or more other modules (e.g., memory module 2160, storage system 2300, network interface 2170, bus 2180, . . . ) of the network node 2100.

The example of FIG. 3 distinguishes two (2) use cases that are affected by the mobility 210 of the network node 2100. For instance, the functionality module 2150 of the network node 2100 may provide for fixed utility (e.g., ceiling lamp, streetlamp, water heater, AC or heating unit, etc.), which would make the network node 2100 a fixed 212 node. In other examples, the functionality module 2150 of the network node 2100 may provide for selective mobility services (e.g., a car, a bus, an electric bicycle, a plane, a delivery drone, etc.), which would make the network node 2100 a momentarily fixed 212 node (e.g., when charging and/or parked and/or idle) or a mobile 214 node (e.g., while moving, i.e., when the functionality module 2150 is under load). In yet other examples, the functionality module 2150 of the network node 2100 may provide for mobile services (e.g., HF communication system, Point of Sale (POS) over data network terminal, portable UPC scanner, etc.), which would make the network node 2100 a mobile 214 node.

When the network node 2100 is behaving as fixed 212 node (whether momentarily or not), a periodic broadcast 220 may be sent by the network node 2100 to detect presence of one or more existing PU clusters. The periodic broadcast may also comprise resources usage data from the network node 2100 (e.g., similar to the exchange 110). The example of FIG. 3 then proceeds to reception 120 of a computation request as previously discussed.

When the network node 2100 is behaving as mobile 214 node, a PU cluster discovery mechanism for neighboring PU cluster(s) may form part of the computation request received 120 by the network node 2100. That is, the network node 2100 may not be aware of the presence of one or more neighboring PU clusters prior to receiving 120 the computation request. An on-demand message may then be sent 222 or broadcast, which may also comprise resources usage data from the network node 2100 (e.g., similar to the exchange 110).

The network node 2100 then coordinates 130, with the neighboring network nodes, creation of one or more PU clusters using resource usage data and taking into account the received 120 computation request. The coordination 130 is performed whether the network node is behaving as a mobility node 214 or a fixed node 212.

Following the coordination 130, when the network node 2100 is behaving as mobile 214 node, a resource connection 224 is performed until the one or more PU clusters are created in accordance with the performed coordination 130. The allocating 140 of resources to the computation request is then performed. In some instances, the allocating 140 of resources may trigger revisit of the resource connection 224.

Following the coordination 130, when the network node 2100 is behaving as fixed 212 node, a resource mapping 226 is performed until the one or more PU clusters are created in accordance with the performed coordination 130. The allocating 140 of resources to the computation request is then performed. In some instances, the allocating 140 of resources may trigger revisit of the resource mapping 224.

Once the computation request has been completed, the result is returned 150 as previously discussed.

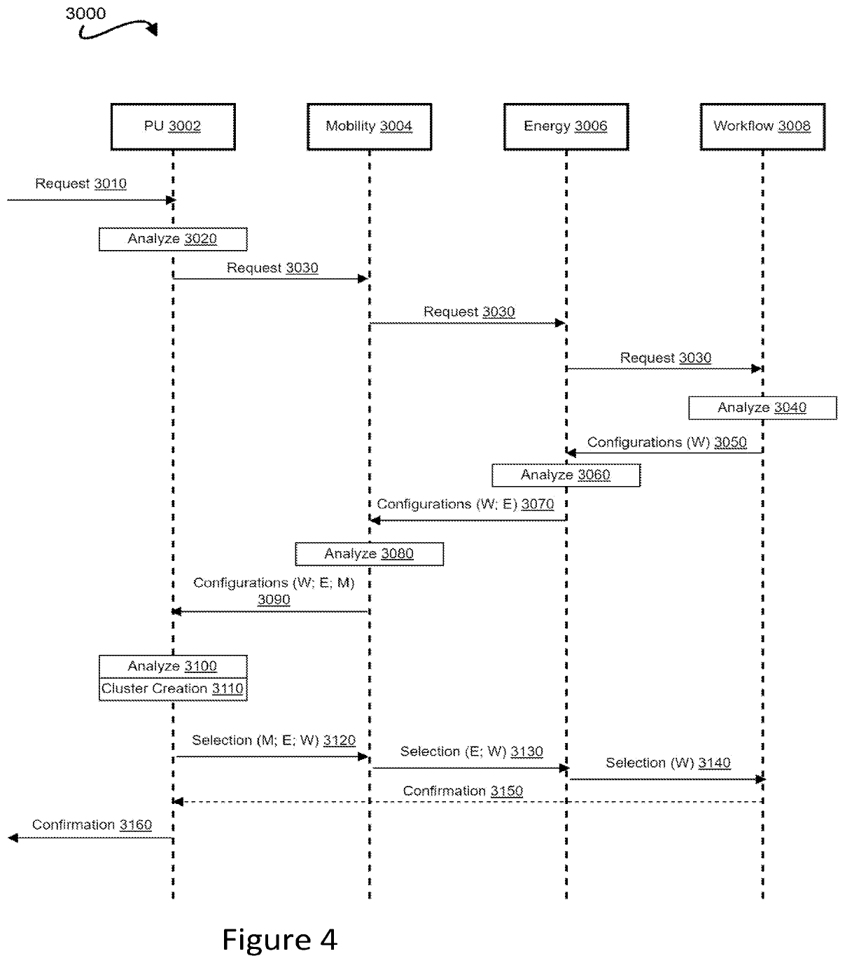

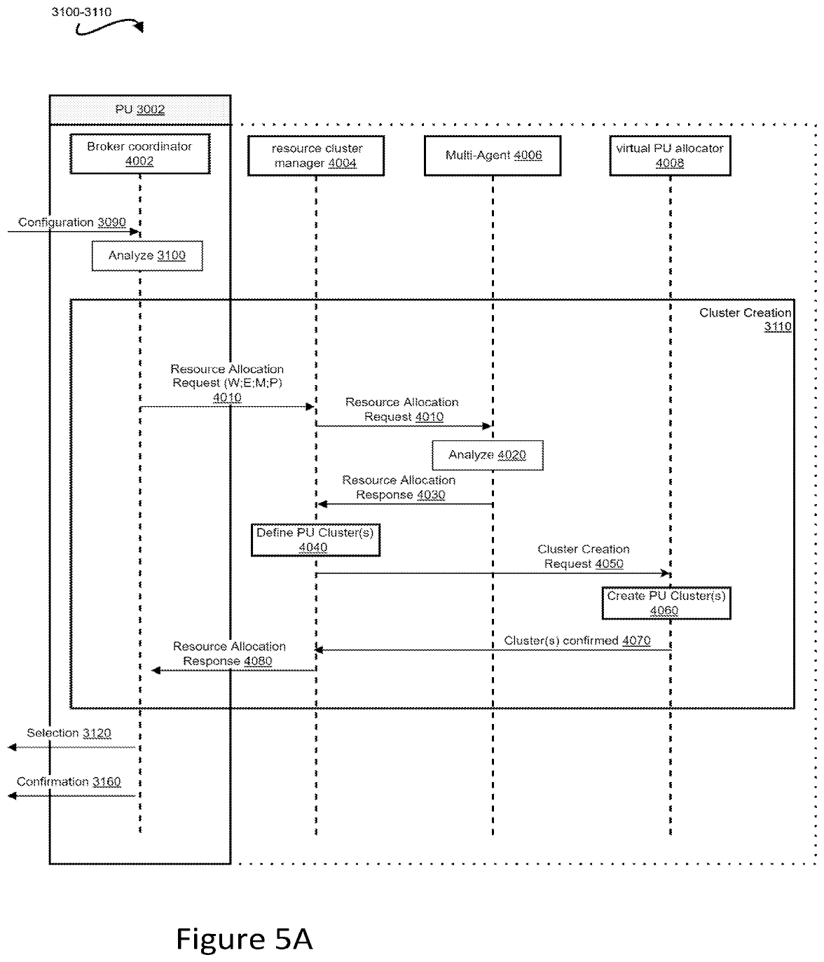

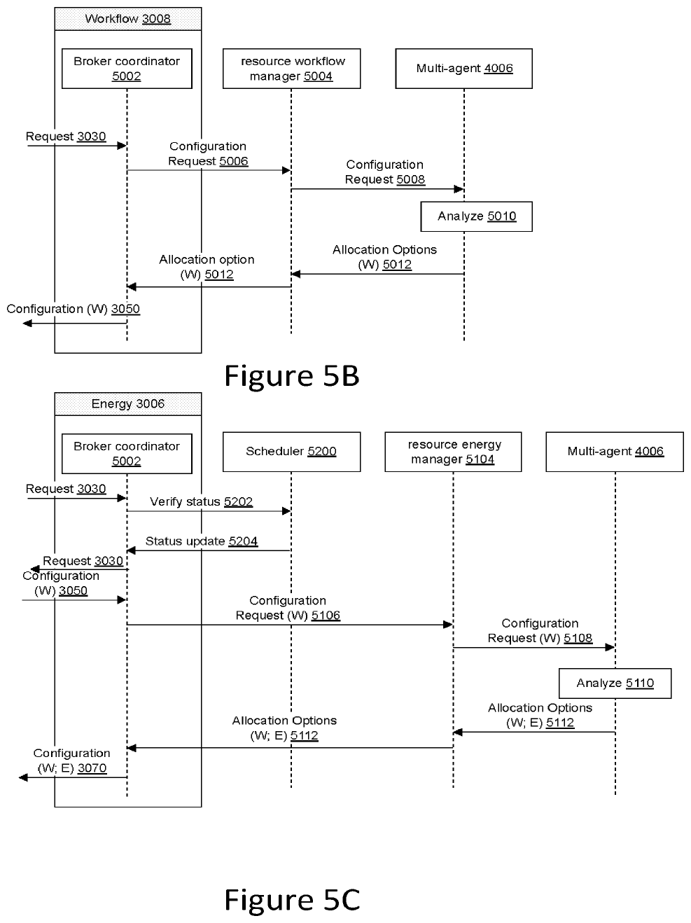

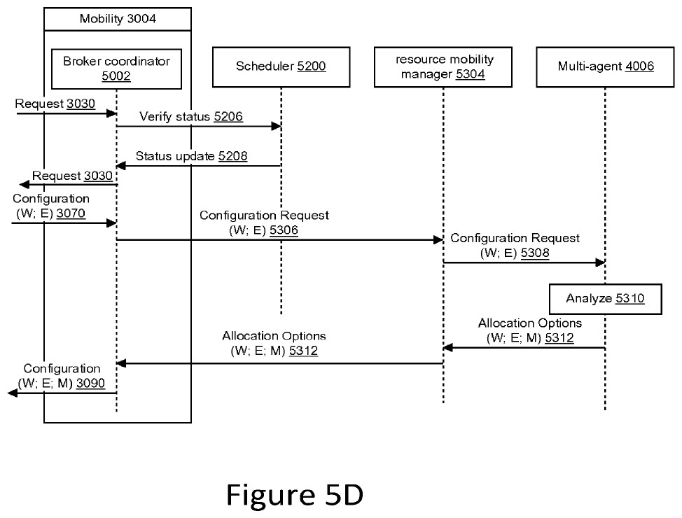

FIGS. 4 and 5 depict an exemplary method 3000 for treating a computation request 3010. The example of FIGS. 4 and 5 depicts a Processing Unit (PU) 3002, a mobility choreographer 3004, an energy choreographer 3006 and a workflow choreographer 3008. In the depicted example, the PU 3002 comprises a broker coordinator 4002 or otherwise has access to the broker coordinator 4002. Skilled persons will recognize that other modes of coordination may be used apart from the broker protocol without affecting the invention (i.e., any distributed middleware framework such as, e.g., Distributed Computing Environment (DCE), RPC (remote procedure call), Client-server, CORBA (Common Object Request Broker Architecture), ORB (object-oriented RPC), DCOM (Distributed Component Object Model), JAVA/RMI (Remote Method Invocation)). A resource cluster manager 4004, a multiagent 4006 and a virtual PU allocator 4008 also participate in the method 3000. In order to support the workflow choreographer 3008, a resource workflow manager 5004 is provided. Likewise, in order to support the energy choreographer 3006 and the mobility choreographer 3004, a resource energy manager 5104 and a resource mobility manager 5214 are respectively provided. Typically, the managers 5004, 5104 and 5204 are implemented using independent modules. A scheduler 5200 provides resources usage information relevant to the execution of the method 3000. In the example of FIGS. 4 and 5, the scheduler 5200 answers to status verification 5206 with status updates 5208 from the broker coordinator 4002. Said differently, the PU 3002 periodically (e.g., on-demand; or at regular or irregular preset intervals) exchanges resource messages with neighboring network nodes using the broker coordinator 4002. Typically, the workflow choreographer 3008 does not expressly require information from the other choreographers as the information about the requested resources is sufficient to provide feasible matching solutions.

Upon receipt of a request 3010, the PU 3002 analyses 3020 the request. The analysis 3020 may be made to discriminate between different characteristics of the received 3020 request. For instance, the analysis 3020 may indicate that the request requires a workflow, energy and/or mobility treatment. Furthermore, the analysis 3020 may be useful in determining when local resources are not sufficient to answer to the received 3010 request. the analysis 3020 may also allow retrieval of detailed information from the received messages (e.g., data source/destination; requested resources; proposed selected configurations; processing delays; data integrity; etc.). In some embodiments, the analysis 3020 is performed by the broker coordinator 4002. The PU 3002 then creates a computation request 3030 from the request 3010 or forwards the request 3010 as the computation request 3020 to the choreographers 3004, 3006 and/or 3008. In the example of FIGS. 4 and 5, the computation request 3030 is forwarded to the mobility choreographer 3004.

The mobility choreographer 3004 forwards the request 3030 when appropriate resources for other characteristics (e.g., energy, workflow). The computation request 3030 is therefore forwarded by the mobility choreographer 3004 to the energy choreographer 3006. The energy choreographer 3004 forwards the request 3030 when appropriate resources for other characteristics (e.g., workflow).

The computation request 3030 is therefore forwarded by the energy choreographer 3006 to the workflow choreographer 3008. The workflow choreographer 3008 then sends a configuration request 5006 to the resource workflow manager 5004. The configuration request 5006 comprises at least those elements from the computation request 3030 that are relevant from a workflow standpoint. The resource workflow manager 5004 forwards the configuration request 5006 to the multiagent 4006 that analyses 5010 the configuration request 5006. An allocation options message 5012 is created as a result of the analysis 5010. The allocation options message 5012 comprises at least one option (W) of resource allocation for the workflow characteristics of the configuration request 5006. The allocation options message 5012 is sent to the resource workflow manager 5004. The resource workflow manager 5004 temporarily reserves or otherwise marks resources that would be required by the one or more options W from the allocation options message 5012. For instance, the resource workflow manager 5004 may exchange messages (not shown) with the scheduler 5200 in order to temporarily reserve or otherwise mark the resources. The resource workflow manager 5004 then forwards the allocation options message 5012 to the workflow choreographer 3008 that selects one or more of the options W and creates a configuration message 3050 comprising the selected configuration (W) that is to be used to answer to the computation request 3030.

Upon receipt of the configuration message 3050, the energy choreographer 3006 sends a configuration request 5106 to the resource energy manager 5104. The configuration request 5106 comprises at least those elements from the computation request 3030 that are relevant from an energy standpoint as well as the selected configuration W received from in the configuration message 3050. The resource energy manager 5104 forwards the configuration request 5106 to the multiagent 4006 that analyses 5110 the configuration request 5106. An allocation options message 5112 is created as a result of the analysis 5110. The allocation options message 5012 comprises the selected workflow configuration W as well as at least one option (E) of resource allocation for the energy characteristics of the configuration request 5106. The allocation options message 5112 is sent to the resource energy manager 5104. The resource energy manager 5104 temporarily reserves or otherwise marks resources that would be required by the one or more options W from the allocation options message 5112. For instance, the resource energy manager 5104 may exchange messages (not shown) with the scheduler 5200 in order to temporarily reserve or otherwise mark the resources. The resource energy manager 5104 then forwards the allocation options message 5112 to the energy choreographer 3006 that selects one or more of the options E and creates a configuration message 3070 comprising the selected configurations (E; W) that are to be used to answer to the computation request 3030.

Upon receipt of the configuration message 3070, the mobility choreographer 3004 sends a configuration request 5306 to the resource mobility manager 5304. The configuration request 5306 comprises at least those elements from the computation request 3030 that are relevant from a mobility standpoint as well as the selected configurations E and W received from in the configuration message 3070. The resource mobility manager 5304 forwards the configuration request 5306 to the multiagent 4006 that analyses 5310 the configuration request 5306. An allocation options message 5312 is created as a result of the analysis 5310. The allocation options message 5012 comprises the selected workflow and energy configurations W and E as well as at least one option (M) of resource allocation for the mobility characteristics of the configuration request 5306. The allocation options message 5312 is sent to the resource mobility manager 5304. The resource energy manager 5304 temporarily reserves or otherwise marks resources that would be required by the one or more options M from the allocation options message 5312. For instance, the resource mobility manager 5104 may exchange messages (not shown) with the scheduler 5200 in order to temporarily reserve or otherwise mark the resources. The resource mobility manager 5304 then forwards the allocation options message 5312 to the mobility choreographer 3004 that selects one or more of the options M and creates a configuration message 3090 comprising the selected configurations (M; E; W) that are to be used to answer to the computation request 3030.

The configuration message 3090 comprising the selected configurations (M; E; W) is then sent to the PU 3002 that analyses 3100 the configuration message 3090 and proceed with the cluster creation 3110. The analysis 3100 may provide an additional processing confirmation configuration (P) (e.g., data source/destination; requested resources; proposed selected configurations; processing delays; data integrity; etc.). A resources allocation request 4010 comprising the selected configurations (P; M; E; W) is then sent to the resource cluster manager 4004, which forwards the resources allocation request 4010 to the multiagent 4006. Upon analyzing 4020 the resources allocation request 4010, the multiagent 4006 sends a resources allocation response 4030 to the resource cluster manager 4004, which, in turns, defines 4040 the corresponding PU cluster(s). A corresponding cluster creation request 4050 may then be sent to the virtual PU allocator to create 4060 (e.g., allowing advertisement thereof) the PU cluster(s). A confirmation message 4070 is then sent towards the resource cluster manager 4004, which provides a resource allocation response 4080 to the PU 3002.

Following reception of the resource allocation response 4080, the PU 3002 then sends a selection configuration message 3120 comprising the selected configurations (M; E; W) to the mobility choreographer 3004. A selection configuration message 3130 comprising at least the selected configurations (E; W) is then sent to the energy choreographer 3006. A selection configuration message 3140 comprising at least the selected configuration (W) is then sent to the workflow choreographer 3006. A confirmation message 3150 may then be sent back toward the PU 3002 (through the other choreographers 3004 and 3006 or not).

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A method executed at a network node for handling a computation request from a requesting party comprising:
periodically exchanging resource messages with neighboring network nodes; and
receiving the computation request from the requesting entity via a network interface;
coordinating, with the neighboring network, creation of one or more Processor Unit (PU) clusters using resource usage data from the resource messages and taking into account the computation request;
allocating resources from the one or more PU clusters to the computation request; and
returning the result of the computation request to the requesting entity via the network interface.

2. The method of claim 1, wherein coordinating the creation of the one or more PU clusters with the neighboring nodes comprises:
computing at least one workflow-configuration compatible with the computation request and the resource usage data; and
taking into account the at least one workflow-configuration, computing a processing-configuration compatible with the computation request and the resource usage data.

3. The method of claim 2, wherein coordinating the creation of the one or more PU clusters with the neighboring nodes further comprises:
taking into account the at least one workflow-configuration, computing at least one energy-configuration compatible with the computation request and the resource usage data;
wherein computing the processing-configuration compatible with the computation request and the resource usage data further takes into account the at least one energy-configuration.

4. The method of claim 3, wherein coordinating the creation of the one or more PU clusters with the neighboring nodes comprises:
taking into account the at least one energy-configuration and the at least one workflow-configuration, computing at least one mobility-configuration compatible with the computation request and the resource usage data; and
wherein computing the processing-configuration compatible with the computation request and the resource usage data further takes into account the at least one mobility-configuration.

5. The method of claim 2, wherein computing the workflow-configuration comprises:
requesting workflow-assignment of resources to a multi-agent function for the computation request, the multi-agent function having access to the computation request and the resource usage data;
receiving the at least one workflow-configuration from the multi-agent function.

6. The method of claim 3, wherein computing the energy-configuration comprises:
requesting energy-assignment of resources to a multi-agent function for the computation request, the multi-agent function having access to the computation request and the resource usage data;
receiving the at least one energy-configuration from the multi-agent function.

7. The method of claim 4, wherein computing the mobility-configuration comprises:
requesting mobility-assignment of resources to a multi-agent function for the computation request, the multi-agent function having access to the computation request and the resource usage data;
receiving the at least one mobility-configuration from the multi-agent function.

8. The method of claim 2, wherein computing the processing-configuration compatible with the computation request is performed upon receipt of at least one energy-configuration and at least one mobility-configuration and comprises:
requesting assignment of the resources from the processing-configuration, one of the at least one energy-configuration and one of the at least one mobility-configuration and one of the at least one workflow-configuration to a multi-agent function;
wherein allocating the resources is performed in accordance with the assignment request upon receipt of a configuration validity confirmation from the multi-agent function.

9. The method of claim 8, wherein allocating the resources comprises:
providing a workflow-configuration-selection message to a workflow-allocation function confirming selection of the one workflow-configuration;
providing an energy-configuration-selection message to an energy-allocation function confirming selection of the one energy-configuration;
providing a mobility-configuration-selection message to a mobility-allocation function confirming selection of the one mobility-configuration; and
providing a processing-configuration-selection message to a processing-allocation function confirming selection of the one processing-configuration;
thereby creating the one or more PU clusters.

10. The method of claim 5, wherein the multi-agent function is distributed among the neighboring nodes.

11. A network node comprising:
one or more Processing Unit (PU) processor cores;
a network interface;
a distributed choreographer module configured to:
periodically exchange resource messages with neighboring network nodes indicating resources usage; and
receive a computation request from a requesting entity via the network interface;
coordinate, with the neighboring network nodes, creation of one or more PU clusters using resource usage data from the resource messages and taking into account the computation request;
allocate resources from the one or more PU clusters to the computation request; and
return the result of the computation request to the requesting entity via the network interface.

12. The network node of claim 11, wherein the distributed choreographer module, when coordinating the creation of the one or more PU clusters with the neighboring nodes, is configured to:
(Original) compute at least one workflow-configuration compatible with the computation request and the resource usage data; and
taking into account the at least one workflow-configuration, compute a processing-configuration compatible with the computation request and the resource usage data.

13. The network node of claim 12, wherein the distributed choreographer module, when coordinating the creation of the one or more PU clusters with the neighboring nodes, ia configured to:
taking into account the at least one workflow-configuration, compute at least one energy-configuration compatible with the computation request and the resource usage data; and
wherein computing the processing-configuration compatible with the computation request and the resource usage data further takes into account the at least one energy-configuration.

14. The network node of claim 13, wherein the distributed choreographer module, when coordinating the creation of the one or more PU clusters with the neighboring nodes, is configured to:
taking into account the at least one energy-configuration and the at least one workflow-configuration, compute at least one mobility-configuration compatible with the computation request and the resource usage data; and
wherein computing the processing-configuration compatible with the computation request and the resource usage data further takes into account the at least one mobility-configuration.

15. The network node of claim 14, wherein the distributed choreographer module, when computing the mobility-configuration, is configured to:
request mobility-assignment of resources to a multi-agent function for the computation request, the multi-agent function having access to the computation request and the resource usage data; and
receive the at least one mobility-configuration from the multi-agent function.

16. The network node of claims 11 to 15, wherein the multi-agent function is distributed among the neighboring nodes.

17. The network node of claim 13, wherein the distributed choreographer module, when computing the energy-configuration, is configured to:
request energy-assignment of resources to a multi-agent function for the computation request, the multi-agent function having access to the computation request and the resource usage data; and
receive the at least one energy-configuration from the multi-agent function.

18. The network node of claim 12, wherein the distributed choreographer module, when computing the workflow-configuration, is configured to:
request workflow-assignment of resources to a multi-agent function for the computation request, the multi-agent function having access to the computation request and the resource usage data; and
receive the at least one workflow-configuration from the multi-agent function.

19. The network node of claim 12, wherein the distributed choreographer module, when computing the processing-configuration compatible with the computation request is performed upon receipt of at least one energy-configuration and at least one mobility-configuration and, is configured to:
request assignment of the resources from the processing-configuration, one of the at least one energy-configuration and one of the at least one mobility-configuration and one of the at least one workflow-configuration to a multi-agent function; and
wherein allocate the resources is performed in accordance with the assignment request upon receipt of a configuration validity confirmation from the multi-agent function.

20. The network node of claim 19, wherein the distributed choreographer module, when allocating the resources, is configured to:
provide a workflow-configuration-selection message to a workflow-allocation function confirming selection of the one workflow-configuration;
provide an energy-configuration-selection message to an energy-allocation function confirming selection of the one energy-configuration;
provide a mobility-configuration-selection message to a mobility-allocation function confirming selection of the one mobility-configuration; and
provide a processing-configuration-selection message to a processing-allocation function confirming selection of the one processing-configuration; and
thereby create the one or more PU clusters.
